(19) United States
(12) Patent Application Publication
(10) Pub. No.: US 2002/0101016 A1
(43) Pub. Date: Aug. 1, 2002

(54) Ceiling joist clamp

(76) Inventor: Christopher Bryan Johnston, London (GB)

Correspondence Address: CHRISTOPHER BRYAN JOHNSTON, 27 GLEBE ROAD, LONDON, CROYDON, SURREY, CR6-9NG, GB

(21) Appl. No.: 10/043,112

(22) Filed: Jan. 14, 2002

(30) Foreign Application Priority Data
Jan. 31, 2001 (GB) GB0102532.9

(51) Int. Cl. B25B 1/20

(52) U.S. Cl. 269/41

(57) ABSTRACT

A Ceiling Joist Clamp (used in pairs for most effectiveness) which can be fitted securely to a ceiling joist or to metal-frame stud to provide a unique supporting ledge that sheet material i.e. Plasterboard can slot onto thus being supported on one side whilst being fixed to the ceiling joist. The support ledge is unique because of its curved profile, bending downwards in a sweeping or radius bend and extending vertically to provide a vital secondary support area to facilitate the lifting of the sheet material up to the ceiling and into the support ledge.

### STATEMENT REGARDING READILY SPONSORED REASEARCH OR DEVELOPMENT

Not Applicable

### REFERENCE TO MICROFICHE APPENDIX

Not Applicable

### BACKGROUND OF THE INVENTION

1. Field of Invention

The present CJC (Ceiling Joist Clamp) invention relates to the building/construction industry both at professional and DIY level to aid the fixing process of sheet materials i.e. Plasterboard (Sheetrock) to ceilings or stud wall partitions.

2. Background Art

Whether wet plastered or dry-lined, plasterboard is the most common sheet material used to stud out walls and ceilings in new buildings, property development and general maintenance. It comes in various forms, thickness and sizes, all of which are heavy, cumbersome and difficult to manhandle when fixing, especially to ceilings. Many builders and homeowners find themselves having to carry out this task on their own. For some this is impossible without anything or anybody to aid them. Sometimes results are achieved by using bits of wood as props to support the board once in place, but these tend to slip or fall. Others manage by using their head to hold the board in position while fixing the screws putting themselves at serious risk of injury.

Attempts have been made to provide tools to assist in the mounting of sheet materials with the obvious objective to reduce the manpower required to carry out this task to one. From a commercial point of view any such clamp is counter productive if it takes one person with a clamp twice as long as two people to carry out the task as it still equates the same labour cost.

For example, U.S. Pat. No. 5,388,813, issued Feb. 14, 1995, to Arsenault, describes a clamp that attaches to a ceiling joist to provide a surface upon which an end or edge of a ceiling panel may be placed when being fixed to a ceiling.

A substantial impracticality and disadvantage of the above clamp is that one person carrying out the task of boarding a ceiling is still going to find it difficult or impossible unless the boards are reduced to a manageable size, thus creating more labour and weakening the ceiling with more joints. Plasterboard is not only heavy it is also brittle and flexible. The problem with clamp Ref.5388813 is that it only offers a small target area (between the underside of the joist and the top edge of the supporting area) in which to feed the board. One clamp on its own does not offer enough support when fixing a 25 kg board. This amount of weight transferred onto a small surface area with sharp edges is likely to break the board if not executed with precision. If two of these clamps are used there will be two small target areas in which to feed the board. When up a ladder holding a 25 kg board above one's head which by nature of the material will arc when held horizontally, means this task will remain difficult, dangerous and still impossible for some. Also this clamp is limited to use with timber joists.

Other efforts such as U.S. Pat. No. 6,161,824 issued December 2000 to Gustavson and U.S. Pat. No. 6,155,547 issued December 2000 to Gatanas require time-consuming fixing procedures and there is the risk of the devices being knocked out of position, if the board is not fed with precision again into the small target area.

None of these clamps or any others cited take into account the difficulty of getting a board from the ground, up to the ceiling and onto the support, whatever that support may be. This renders a clamp useless if one cannot get the board up to it in the first place.

Accordingly, it is a principal objective of the present invention to provide a clamp that assists the elements of this difficult and hazardous task in its entirety.

It is a further objective to provide a clamp that is lightweight and quick and easy to use. And with an additional wedge that gives this clamp the added advantage of being able to secure to metal tracking used in suspended ceilings. The present invention, as well as the particular features, elements and advantages thereof, will be apparent from the following description and the accompanying drawings. However minor alterations, improvements or fine-tuning of the present invention may be incorporated without departing from the spirit of this invention. It should therefore be understood that the invention is not limited to what is described in the specification and drawings, which should not be interpreted in a limited sense.

### BRIEF SUMMARY OF THE INVENTION

The CJC (Ceiling Joist Clamp) that I have invented overcomes the above objectives by providing in a preferred embodiment, a clamp to assist in the lifting and the mounting of sheet materials to a ceiling. It has been designed taking in to account the problematic qualities of the sheet material. The present invention offers assistance to the fitter from a much earlier stage in the fixing process. The support ledge is bent and hangs vertically down from the ceiling joist to which the clamp is fitted, to facilitate the lifting of the sheet material and the locating of it onto the support ledge. Two attached cross members of differing heights determines the angle of projection of the support ledge, and the spacing of it from the underside of the joist where the clamp is fitted. These also provide lateral support to the two adjoining side panels, which will accommodate the joist and provide means for securing to the joist by way of a threaded bolt, with a leverage handle passing through one of the side panels. When rotating the handle, the bolt pinches the timber joist against the opposite side panel that features spikes or a textured finish on the inside face for maximum grip. When using the clamp on metal tracking a triangular shaped wedge can be positioned in between the two side panels of the CJC, above the track so to provide a downward force pinching the track between the said wedge and the cross members when the threaded bolt is rotated.

### BRIEF DESCRIPTION OF THE SEVERAL VIEWS OF DRAWINGS

FIG. 1 shows in perspective the Ceiling Joist Clamp

FIG. 2 shows the front elevation of the Ceiling Joist Clamp

FIG. 3 shows the side elevation of the Ceiling Joist Clamp

FIG. 4 shows one of the two CJCs fitted to the ceiling joist (from side elevation) with plasterboard (sheetrock) poised to be lifted.

FIG. 5 shows one of the CJCs fitted to the ceiling joist (from side elevation) supporting the plasterboard (sheetrock) now in position to be fixed. Until fixings are in place the side marked 1 still needs to be manually supported.

FIG. 6 shows the process being repeated to complete the ceiling.

FIG. 7 shows the front elevation of FIG. 4.

FIG. 8 shows the clamp fixed to metal tracking using the wedge.

FIG. 9 shows the perspective of the wedge.

### DETAILED DESCRIPTION OF THE DRAWING

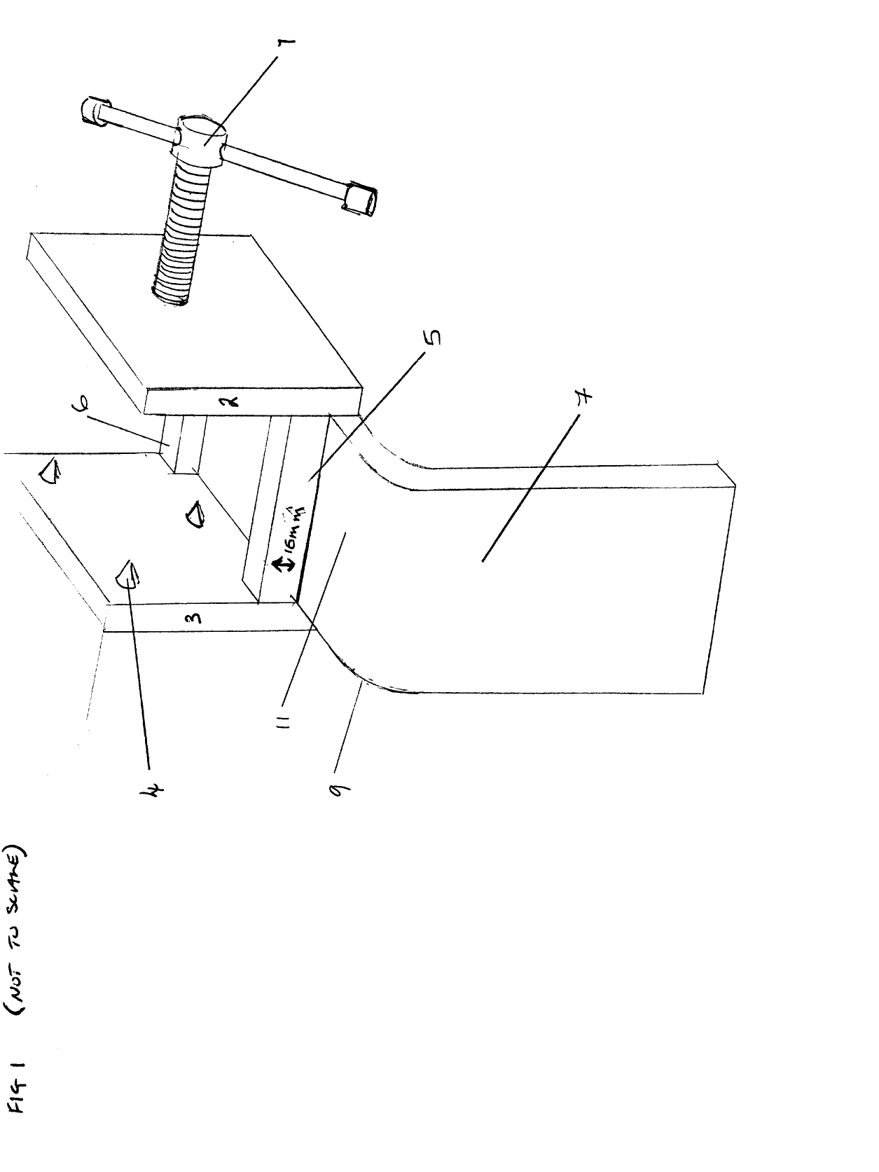

Referring to FIG. 1, the CJC has two side panels marked 2 and 3, side 3 has spikes marked 4, side 2 has a threaded bolt marked I passing through it. The bolt is tapered one end (not seen) and has a handle for leverage at the other end. There are two cross members marked 5 and 6, 5 being higher than 6, determining the angle of projection, and the spacing from the ceiling joist the adjoining base plate marked 11 (dogleg shaped). This extends away from the main body to form the horizontal, supporting ledge before bending in a sweeping or radius bend marked 9 to form the vertical support plate marked 7. Please note that items marked 7, 9 and 11 compose a single piece.

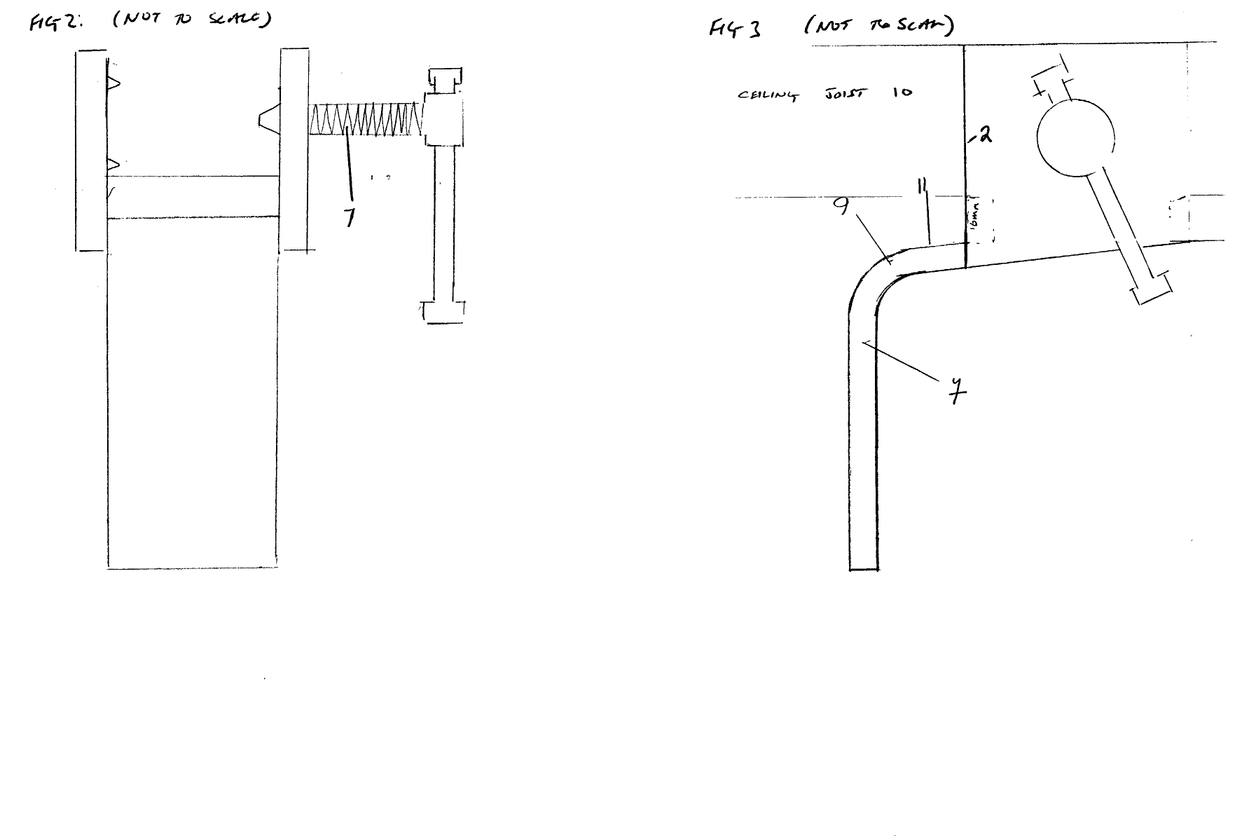

When boarding a ceiling, the first stage in using the ceiling joist clamp is to measure the width of the board to be fixed. Select two joists equidistantly spaced in relation to the length of the board. From the wall measure the width of the board along the selected joists and mark with a pencil. Line the front edge of the CJC marked 2 in FIG. 3 to the pencil mark and secure the clamp in position by turning the threaded bolt marked 1 in FIG. 1, until the timber is pinched between the spikes marked 4 in FIG. 1 and the tapered ended bolt marked 1 in FIG. 2. The cross members of the clamp marked 5 and 6 in FIG. 1 (5 being a minimum of 16 mm in height) act as spacers to ensure sufficient space is left between the top of the ledge marked 11 in FIG. 3 and the ceiling joist marked 10 in FIG. 3. This ensures space for the board to slip into and be supported.

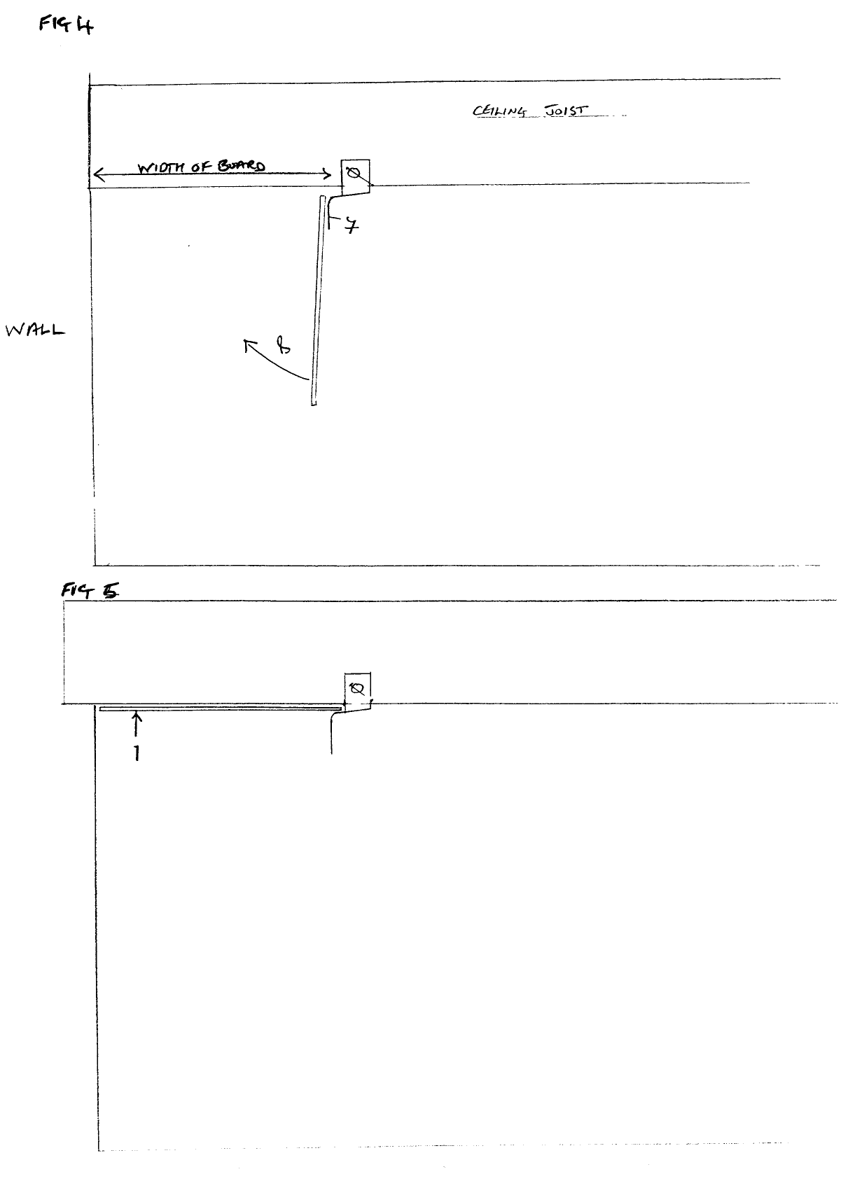

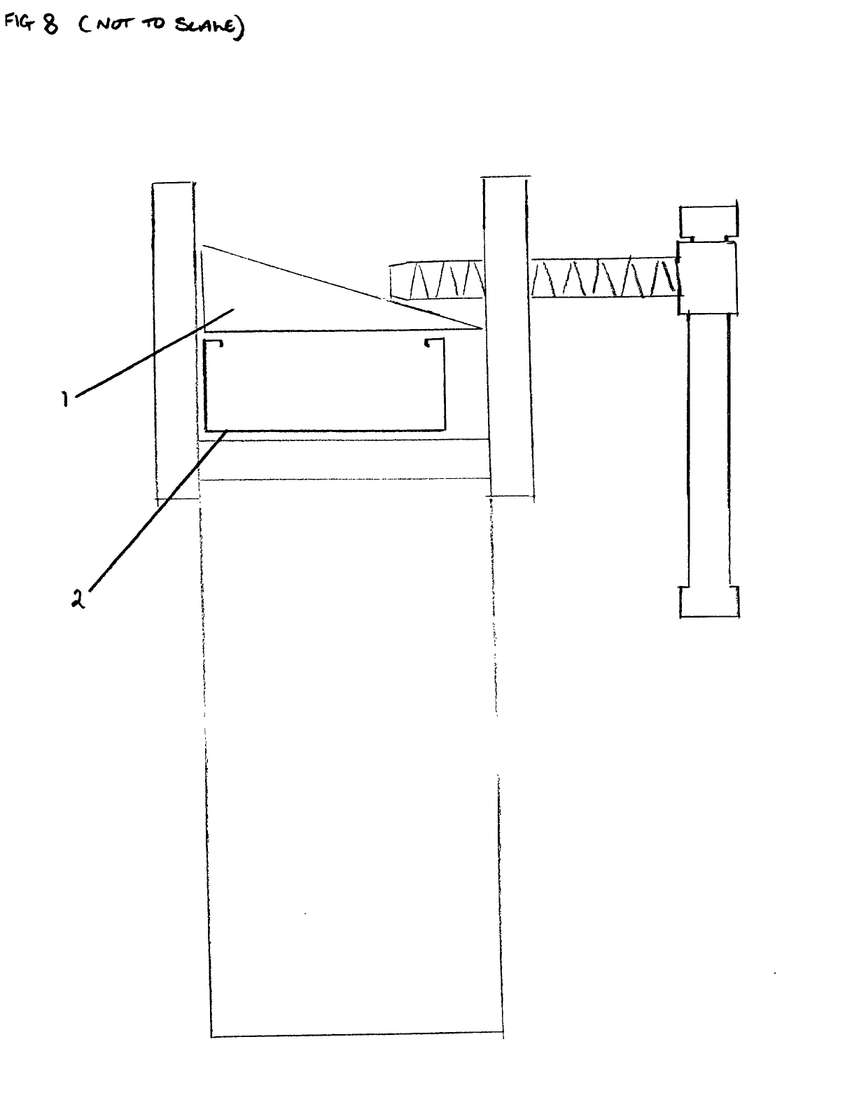

Lift one board on its side, keeping it vertical and lean it against the vertical support plates of the two CJCs marked 7 in FIG. 4 and FIG. 7(front and side elevations). The board can be rested here to enable the fitter to change hands if a more favourable lifting position is necessary. The vertical drop of the plate marked 7 in FIG. 1 will be approximately 150 mm offering an allowance for movement or slippage during this transitional period. A room with higher ceilings may require the use of clamps with slightly longer vertical supports for increased safety.

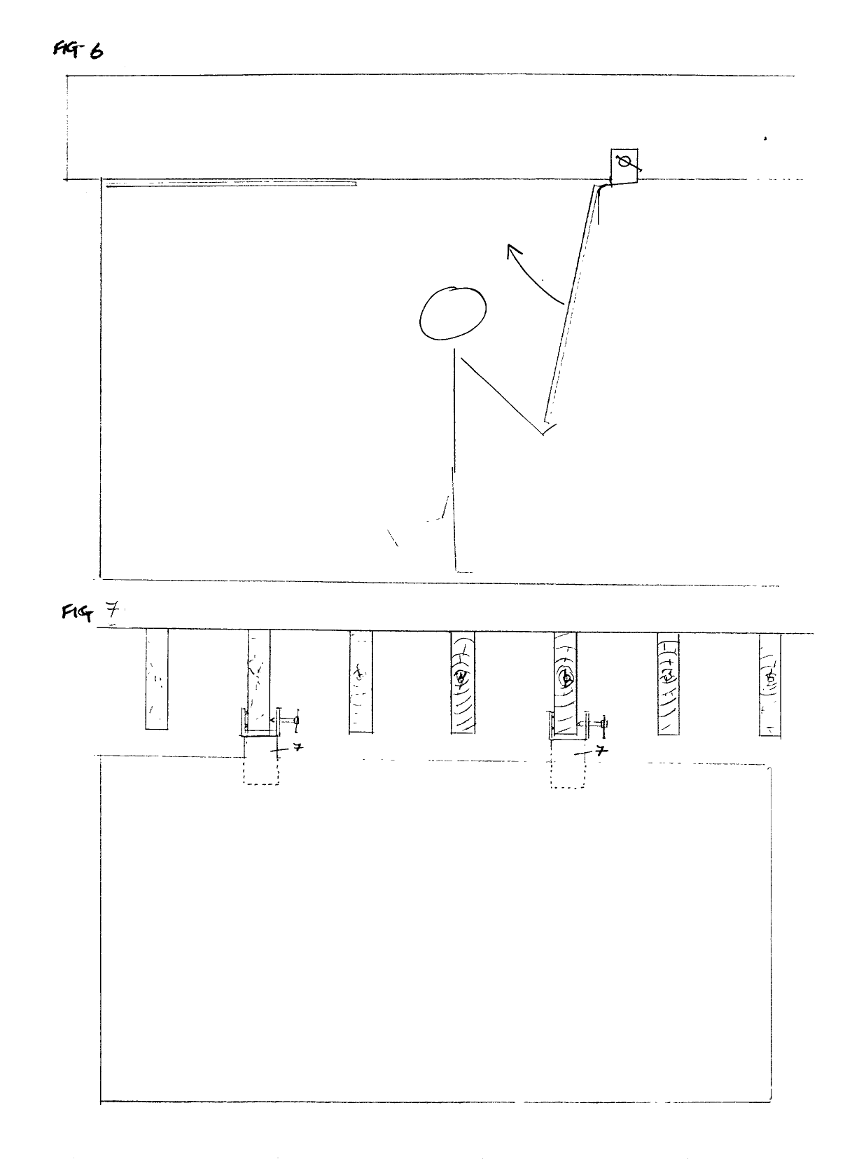

When the board is in position, rotate it in the direction of the arrow 8 in FIG. 4 while also pushing it into the clamp. The edge of the board will slip into the recess between the joist and the supporting ledge of the CJC, thus being supported on one side as in FIG. 5.

The rounded profile of the CJC's support ledge marked 9 in FIG. 3, limits resistance and or restriction that a sharp corner or edge would impose. It maximises the opening of the support ledge and smoothly guides the edge of the board into the recess. While holding the other side of the board marked 1 in FIG. 5 with one hand, fix screws with the other hand. Once all fixings are in place the CJCs can be removed. Repeat the process measuring from the edge of the previous board until ceiling is complete.

The CJC can also be used on vertical stud walls following the same procedure, measuring from the top of the wall and working downward.

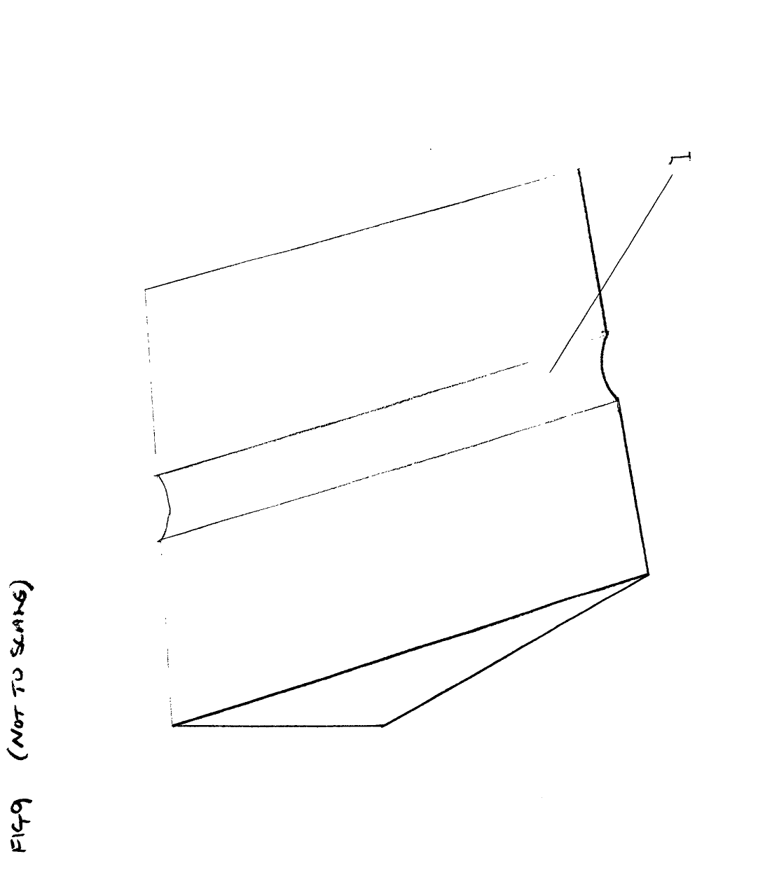

The CJC can also be used on metal-framed suspended ceilings by incorporating an additional wedge as seen marked I in FIG. 8. When the threaded bolt is rotated against the wedge, a downward force will occur pinching the ceiling frame marked 2 in FIG. 8, obtaining a secure and ridged fixing. The wedge will feature a location groove marked 1 in FIG. 9 that the tip of the bolt will slide to prevent the wedge from slipping out from the clamp when the bolt is rotating.

1. I claim: a Ceiling Joist Clamp comprising of two side panels featuring means for securing to a timber joist, adjoining cross members give the sides rigidity and also act as spacers to determine the void between the joist and the adjoining base plate which extends away from the side panels to form a supporting ledge before bending in a radius or sweeping bend to form a vertical support.

2. I claim: a Ceiling Joist Clamp as claimed in claim 1 wherein means for securing to a timber joist where by one side panel featuring a series of spikes on its inside face, with the other side having a threaded bolt with leverage handle passing through it, when rotated it beds itself and the spikes into the joist thus achieving a ridged fixing.

3. I claim: a Ceiling Joist Clamp as claimed in claim 1 wherein the cross members act as spacers, the front spacer determining the void between the joist and the ledge of the CJC will be approximately 16 mm in height making the clamp compatible with sheet material up to 15 mm thick; the back spacer will be approximately 9 mm in height thus determining the angle of projection of the base plate which extends to become the support ledge.

4. I claim: a Ceiling Joist Clamp as claimed in claim I wherein the base plate, supporting ledge, the sweeping or radius bend and the vertical support plate are formed from a single piece of material for maximum strength.

5. I claim: a Ceiling Joist Clamp as claimed in claim 4 wherein the radius bend limits resistance and or restriction when feeding the edge of the sheet material into the supporting ledge area of the clamp.

6. I claim: a Ceiling Joist Clamp as claimed in claim 1 and 4 wherein the vertical support means that when the clamp is fitted to a ceiling joist the vertical support hangs vertically approximately 150 mm down from the joist thus providing a solid area for resting or leaning the sheet material against; the vertical support also acts as a guide as the board slides up the face of the vertical support when feeding on to the support ledge.

7. I claim: a Ceiling Joist Clamp as claimed in claim 1 and 4 wherein a supporting ledge means to provide a solid surface area extending from the main body of the clamp approximately 16 mm below the ceiling joist

8. I claim: a Ceiling Joist Clamp as claimed in claim 1 that can be secured to metal-framed ceilings when incorporating a triangular wedge between the two side panels.

9. I claim: a triangular wedge as claimed in claim 8 that features a location channel.

10. I claim: a Ceiling Joist Clamp substantially described herein with reference to FIGS. 1-9 of the accompanying drawings.
